(19) United States
(12) Patent Application Publication
(10) Pub. No.: US 2015/0030851 A1
(43) Pub. Date: Jan. 29, 2015

(54) COMPOSITE REINFORCER SHEATHED WITH A RUBBER SELF-ADHESIVE POLYMER LAYER

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: Vincent Abad, Clermont-Ferrand (FR); Sébastien Rigo, Clermont-Ferrand (FR); Emmanuel Custodero, Clermont-Ferrand (FR)

(21) Appl. No.: 14/376,715

(22) PCT Filed: Jan. 31, 2013
(86) PCT No.: PCT/EP2013/051842

§ 371 Date: Aug. 5, 2014

(30) Foreign Application Priority Data
Feb. 8, 2012 (FR) 1251156

(51) Int. Cl. B60C 9/00; C08L 21/00

(52) U.S. Cl. CPC B60C 9/0007; C08L 21/00; B60C 2009/0021; C08L 2205/03
USPC 428/378; 428/375; 428/390; 427/386; 524/440

(57) ABSTRACT

A composite reinforcer capable of adhering directly to a diene rubber matrix, which can be used in particular as a reinforcing element for a tyre, comprises: one or more reinforcing thread(s), for example a thread or cord made of carbon steel; and a layer of a polymer composition which covers the said thread, individually each thread or collectively several threads, this layer comprising at least one thermoplastic polymer, the glass transition temperature of which is positive, such as, for example, a polyamide, and an epoxidized diene elastomer, such as, for example, natural rubber or a butadiene homopolymer or copolymer. A process for the manufacture of such a composite reinforcer, and a finished article or semi-finished product made of rubber, in particular a tyre, incorporating such a composite reinforcer are also disclosed.

### FIELD OF THE INVENTION

The field of the present invention is that of reinforcing elements or “reinforcers”, in particular metal ones, which can be used to reinforce finished articles or semi-finished products made of diene rubber, such as, for example, tyres.

The present invention relates more particularly to reinforcers of the hybrid or composite type composed of at least one core, in particular metal core, the said core being covered or sheathed with a layer or sheath of polymer material.

### PRIOR ART

The sheathing of metal reinforcers with polymer materials, in particular thermoplastic materials, such as, for example, polyamide or polyester, has been known for a very long time, in particular in order to protect these reinforcers from various types of external attack, such as oxidation or abrasion, or else for the purpose of structurally stiffening, rendering them integral with one another, various groups of threads or assemblies of threads, such as cords, and thus increasing in particular their buckling resistance.

Such composite reinforcers, and their use in rubber articles, such as tyres, have been described in numerous patent documents.

Patent Application EP 0 962 562 has described, for example, a reinforcer, made of steel or of aramid textile, sheathed by a thermoplastic material, such as polyester or polyamide, for the purpose of improving its abrasion resistance.

Patent Application FR 2 601 293 has described the sheathing of a metal cord with polyamide in order to use it as bead wire in a pneumatic tyre bead, this sheathing advantageously making it possible to adjust the shape of this bead wire to the structure and to the operating conditions of the bead of the pneumatic tyre which it reinforces.

Patent documents FR 2 576 247 and U.S. Pat. No. 4,754,794 have also described metal cords or threads which can be used as bead wire in a pneumatic tyre bead, these threads or cords being doubly-sheathed or indeed even triply-sheathed by two or respectively three different thermoplastic materials (e.g. polyamides) having different melting points, for the purpose, on the one hand, of controlling the distance between these threads or cords and, on the other hand, of eliminating the risks of wear by rubbing or of corrosion, in order to use them as bead wire in a pneumatic tyre bead.

These reinforcers thus sheathed with polyester or polyamide material have, apart from the abovementioned advantages of corrosion resistance, abrasion resistance and structural rigidity, the not insignificant advantage of being able to be subsequently bonded to diene rubber matrices using simple textile adhesives, called RFL (resorcinol-formaldehyde latex) adhesives, comprising at least one diene elastomer, such as natural rubber, which adhesives in a known way confer satisfactory adhesion between textile fibres, such as polyester or polyamide fibres, and a diene rubber.

Thus, use may advantageously be made of metal reinforcers not coated with adhesive metal layers, such as brass, and also surrounding rubber matrices devoid of metal salts, such as cobalt salts, which are necessary in a known way for maintaining the adhesive performance over the course of time but which significantly increase, on the one hand, the cost of the rubber matrices themselves and, on the other hand, their sensitivity to oxidation and to ageing (see, for example, Patent Application WO 2005/113666).

However, the above RFL adhesives are not without drawbacks; in particular, they comprise, as base substance, formaldehyde (or methanal) and also resorcinol, which it is desirable in the long-term to eliminate from adhesive compositions because of the recent developments in European regulations regarding products of this type.

Thus, the designers of diene rubber articles, especially tyre manufacturers, are currently seeking novel adhesive systems or novel reinforcers which make it possible to overcome all or some of the abovementioned drawbacks.

The recently published Applications WO 2010/105975, WO 2010/136389, WO 2011/012521 and WO 2011/051204 disclose composite reinforcers, in particular comprising a metal core, of the self-adhesive type which meet the above objective, these reinforcers exhibiting levels of adhesion to rubber which are broadly competitive with those achieved with conventional RFL adhesives.

However, they have the disadvantage that their manufacturing process involves two successive sheathing or covering stages, first of all requiring the deposition of a first layer of thermoplastic polymer, such as polyamide, and subsequently the deposition of a second layer of unsaturated thermoplastic elastomer, the two depositions, carried out at different temperatures, also being separated by an intermediate stage of cooling with water (for solidification of the first layer) and then drying.

These successive handling operations are somewhat detrimental from the industrial viewpoint and conflict with the search for high manufacturing rates.

### BRIEF DESCRIPTION OF THE INVENTION

On continuing their research studies, the Applicant Companies have discovered a novel composite reinforcer of self-adhesive type which it too makes it possible to achieve excellent levels of adhesion, compared to the use of RFL adhesives, while offering a simplified manufacturing process, compared to the processes described in the abovementioned patent applications, since it requires only a single sheathing operation.

Consequently, a first subject-matter of the invention relates to a composite reinforcer comprising:
one or more reinforcing thread(s);
a layer of a polymer composition which covers the said thread, individually each thread or collectively several threads, this composition comprising at least one thermoplastic polymer, the glass transition temperature of which is positive, and an expoxidized diene elastomer.

It has unexpectedly been observed that the use of this specific polymer composition, as a monolayer, makes it possible to ensure a direct and effective adhesion of the composite reinforcer of the invention to a diene elastomer matrix or composition, such as those commonly used in tyres.

The invention also relates to a process for the manufacture of the above composite reinforcer, the said process comprising at least one stage in which the reinforcing thread or each reinforcing thread is individually covered, or several reinforcing threads are collectively covered, by the layer of the abovementioned polymer composition.

The present invention also relates to the use of the composite reinforcer of the invention as reinforcing element for finished articles or semi-finished products made of rubber, in particular tyres, especially those intended to equip motor vehicles of passenger vehicle type, sport utility vehicles (“SUVs”), two-wheel vehicles (in particular bicycles and motorcycles), aircraft, as for industrial vehicles chosen from vans, heavy-duty vehicles, that is to say underground trains, buses, heavy road transport vehicles (lorries, tractors, trailers) or off-road vehicles, such as heavy agricultural vehicles or earthmoving equipment, or other transportation or handling vehicles.

The invention also relates per se to any finished article or semi-finished product made of rubber, in particular a tyre, comprising a composite reinforcer according to the invention.

The invention and its advantages will be easily understood in the light of the description and implementational examples which follow, and also of the figures relating to these examples, which diagrammatically show:

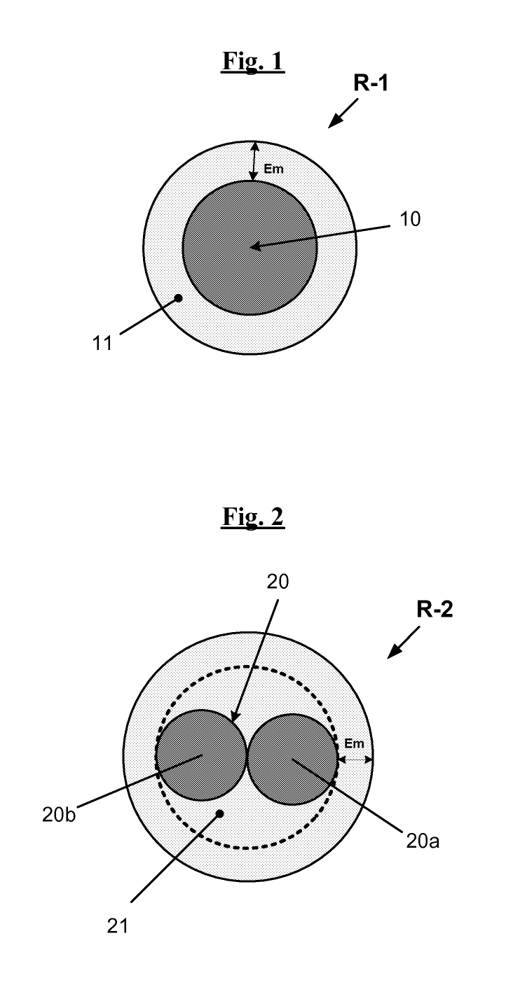

in cross section, an example of a composite reinforcer according to the invention (FIG. 1);

in cross section, another example of a reinforcer in accordance with the invention (FIG. 2);

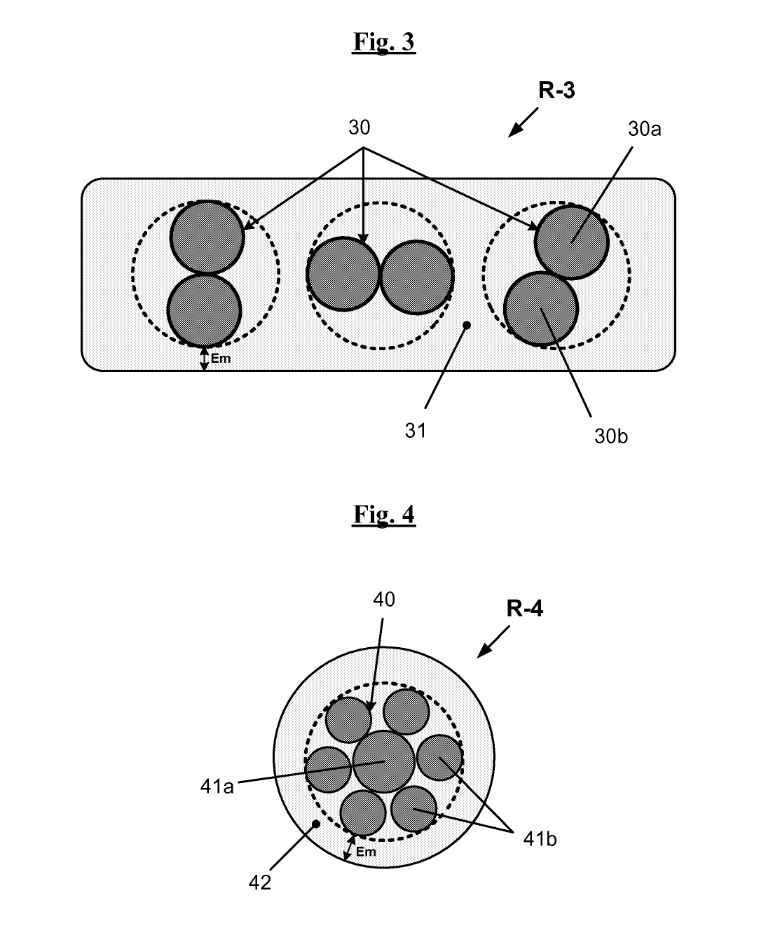

in cross section, another example of a reinforcer in accordance with the invention (FIG. 3);

in cross section, another example of a reinforcer in accordance with the invention (FIG. 4);

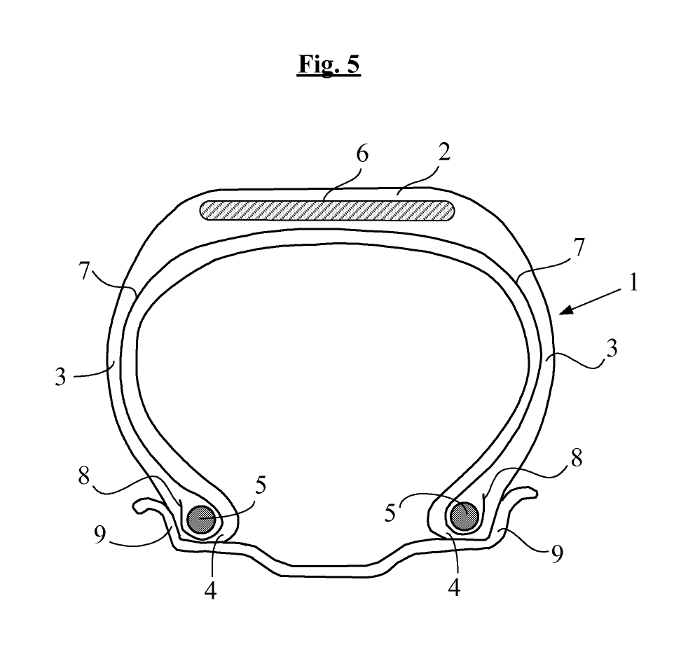

in radial section, a tyre having a radial carcass reinforcement in accordance with the invention, incorporating a composite reinforcer according to the invention (FIG. 5).

### DETAILED DESCRIPTION OF THE INVENTION

In the present description, unless expressly indicated otherwise, all the percentages (%) shown are percentages by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The composite reinforcer of the invention, capable of adhering directly, by curing, to an unsaturated rubber composition and able to be used in particular for reinforcing articles made of diene rubber, such as tyres, thus has the essential characteristics of comprising:
at least one reinforcing thread (that is to say, one or more threads);
a layer of a polymer composition which covers individually the said thread, each thread or collectively several threads, this composition comprising at least one thermoplastic polymer, the glass transition temperature of which (denoted hereinafter Tg₁) is positive (that is to say, greater than 0° C.), and an epoxidized diene elastomer.

In other words, the composite reinforcer of the invention comprises a single reinforcing thread or several reinforcing threads, the said thread, individually each thread or collectively several threads, being covered by a layer (monolayer) or sheath of the abovementioned polymer composition. The structure of the reinforcer of the invention is described in detail below.

In the present application, the term “reinforcing thread” is generally understood to mean any elongate element of great length relative to its cross section, whatever the shape, for example circular, oblong, rectangular, square, or even flat, of this cross section, it being possible for this thread to be straight or not straight, for example twisted or wavy.

This reinforcing thread can take any known form. For example, it can be an individual monofilament of large diameter (for example and preferably equal to or greater than 50 μm), an individual ribbon, a multifilament fibre (consisting of a plurality of individual filaments of small diameter, typically of less than 30 μm), a textile twisted yarn formed from several fibres twisted together, a textile or metal cord formed from several fibres or monofilaments cabled or twisted together, or else an assembly, group or row of threads, such as, for example, a band or strip comprising several of these monofilaments, fibres, twisted yarns or cords grouped together, for example aligned along a main direction, whether straight or not.

The or each reinforcing thread has a diameter which is preferably less than 5 mm, in particular within a range from 0.1 to 2 mm.

Preferably, the reinforcing thread is a metal reinforcing thread, in particular a thread made of carbon steel, such as those used in steel cords for tyres. However, it is of course possible to use other types of steel, for example stainless steel. When a carbon steel is used, its carbon content is preferably between 0.4% and 1.2%, in particular between 0.5% and 1.1%. The invention applies in particular to any steel of the normal tensile (“NT”), high tensile (“HT”), super high tensile (“SHT”) or ultra-high tensile (“UHT”) steel cord type.

The steel might be coated with an adhesive layer, such as brass or zinc. However, advantageously a bright, that is to say uncoated, steel may be used. Furthermore, by virtue of the invention, the rubber composition intended to be reinforced by a metal reinforcer according to the invention no longer requires the use in its formulation of metal salts, such as cobalt salts.

The polymer composition constituting the above layer or sheath first of all comprises a thermoplastic polymer for which the Tg (Tg₁) is by definition positive (in particular between 0° C. and 200° C.), preferably greater than +20° C. (in particular between 20° C. and 150° C.), more preferably greater than +30° C. (in particular between 30° C. and 150° C.). Moreover, the melting point (denoted M.p.) of this thermoplastic polymer is preferably greater than 100° C., more preferably greater than 150° C., in particular greater than 200° C.

This thermoplastic polymer is preferably selected from the group consisting of polyamides, polyesters and polyimides, more particularly from the group consisting of polyesters and aliphatic polyamides. Mention may be made, among the polyesters, for example, of PET (polyethylene terephthalate), PEN (polyethylene naphthalate), PBT (polybutylene terephthalate), PBN (polybutylene naphthalate), PPT (polypropylene terephthalate) and PPN (polypropylene naphthalate). Mention may in particular be made, among the aliphatic polyamides, of the polyamides PA-4,6, PA-6, PA-6,6, PA-11 or PA-12. This thermoplastic polymer is preferably an aliphatic polyamide, more preferably a polyamide 6 or a polyamide 11.

The second essential constituent of the polymer composition is a diene elastomer bearing epoxide groups or functional groups, that is to say that the diene elastomer is an epoxidized diene elastomer.

It should be remembered that elastomer or rubber (the two terms being in a known way synonymous and interchangeable) of the “diene” type should be understood as meaning an elastomer which results at least in part (i.e., a homopolymer or a copolymer) from diene monomers (monomers bearing two conjugated or non-conjugated carbon-carbon double bonds).

These diene elastomers, in the present patent application by definition non-thermoplastic, exhibiting a Tg which in the very great majority of cases is negative (that is to say, less than 0° C.), can be categorized in a known way into two categories: those referred to as “essentially unsaturated” and those referred to as “essentially saturated”. Butyl rubbers, such as, for example, copolymers of dienes and of α-olefins of EPDM type, come within the category of essentially saturated diene elastomers, having a content of units of diene origin which is low or very low, always less than 15% (mol %). In contrast, essentially unsaturated diene elastomer is understood to mean a diene elastomer resulting at least in part from conjugated diene monomers, having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

It is preferable to use at least one diene elastomer of the highly unsaturated type, in particular a diene elastomer selected from the group consisting of natural rubber (NR), synthetic polyisoprenes (IRs), polybutadienes (BRs), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and the mixtures of such copolymers.

The above diene elastomers can, for example, be block, statistical, sequential or microsequential elastomers and can be prepared in dispersion or in solution; they can be coupled and/or star-branched or else functionalized with a coupling and/or star-branching or functionalization agent.

The following are preferably suitable: polybutadienes and in particular those having a content of 1,2- units of between 4% and 80% or those having a content of cis-1,4- units of greater than 80%, polyisoprenes, butadiene/styrene copolymers and in particular those having a styrene content of between 5% and 50% by weight and more particularly between 20% and 40%, a content of 1,2- bonds of the butadiene part of between 4% and 65% and a content of trans-1,4- bonds of between 20% and 80%, butadiene/isoprene copolymers and in particular those having an isoprene content of between 5% and 90% by weight and a glass transition temperature from −40° C. to −80° C., or isoprene/styrene copolymers and in particular those having a styrene content of between 5% and 50% by weight and a Tg of between −25° C. and −50° C.

In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2- units of the butadiene part of between 4% and 85%, a content of trans-1,4- units of the butadiene part of between 6% and 80%, a content of 1,2- plus 3,4- units of the isoprene part of between 5% and 70% and a content of trans-1,4- units of the isoprene part of between 10% and 50%, and more generally any butadiene/styrene/isoprene copolymer having a Tg of between −20° C. and −70° C., are suitable in particular.

The Tg of the thermoplastic polymers and of the diene elastomers described above is measured in a known way by DSC (Differential Scanning calorimetry), for example and unless specifically indicated otherwise in the present patent application, according to Standard ASTM D3418 of 1999.

A second essential characteristic of the diene elastomer used in the composite reinforcer of the invention is that it is epoxide-functionalized.

Such functionalized diene elastomers and their processes of preparation are well-known to a person skilled in the art and are commercially available. Diene elastomers bearing epoxide groups have been described, for example, in US 2003/120007 or EP 0 763 564, U.S. Pat. No. 6,903,165 or EP 1 403 287.

Preferably, the epoxidized diene elastomer is selected from the group consisting of epoxidized natural rubbers (NRs), epoxidized synthetic polyisoprenes (IRs), epoxidized polybutadienes (BRs) preferably having a content of cis-1,4- bonds of greater than 90%, epoxidized butadiene/styrene copolymers (SBRs) and the mixtures of these elastomers.

Natural rubbers (abbreviated to “ENRs”), for example, can be obtained in a known way by epoxidation of natural rubber, for example by processes based on chlorohydrin or on bromohydrin or processes based on hydrogen peroxides, on alkyl hydroperoxydes or on peracides (such as peracetic acid or performic acid); such ENRs are, for example, sold under the names “ENR-25” and “ENR-50” (respective degrees of epoxidation of 25% and 50%) by Guthrie Polymer. Epoxidized BRs are themselves also well-known, for example sold by Sartomer under the name “Poly Bd” (for example, “Poly Bd 605E”). Epoxidized SBRs can be prepared by epoxidation techniques well-known to a person skilled in the art.

The degree (mol %) of epoxidation of the epoxidized diene elastomers described above can vary to a great extent according to the specific embodiments of the invention, preferably within a range from 5% to 60%. When the degree of epoxidation is less than 5%, there is a risk of the targeted technical effect being insufficient whereas, above 60%, the molecular weight of the polymer greatly decreases. For all these reasons, the degree of epoxidation is more preferably within a range from 10% to 50%.

The epoxidized diene elastomers described above are in a known way solid at ambient temperature (20° C.); the term “solid” is understood to mean any substance not having the ability to eventually assume, at the latest after 24 hours, solely under the effect of gravity and at ambient temperature (20° C.), the shape of the container in which it is present.

In contrast in particular to elastomers of the liquid type, these solid elastomers are characterized by a very high viscosity: their Mooney viscosity in the raw state (i.e., non-crosslinked state), denoted ML (1+4), measured at 100° C., is preferably greater than 20, more preferably greater than 30 and in particular between 30 and 130. Use is made, for this measurement, of an oscillating consistometer as described in Standard ASTM D1646 (1999). The measurement is carried out according to the following principle: the sample, analysed in the raw state (i.e., before curing), is moulded (shaped) in a cylindrical chamber heated to a given temperature (for example 100° C.). After preheating for 1 minute, the rotor rotates within the test specimen at 2 revolutions/minute and the working torque for maintaining this movement is measured after rotating for 4 minutes. The Mooney viscosity (ML 1+4) is expressed in “Mooney unit” (MU, with 1 MU=0.83 newton.metre).

Although the two constituents described above (thermoplastic polymer and epoxidized diene elastomer) are sufficient in themselves alone to confer, on the composite reinforcer of the invention, very high properties of adhesion to an unsaturated rubber, such as natural rubber, certain conventional additives, such as colourant, filler, plasticizer, tackifying agent, antioxidant or other stabilizer, crosslinking or vulcanization system, such as sulphur, and accelerator, might optionally be added to the polymer composition described above.

The appended FIG. 1 represents very diagrammatically (without observing a specific scale), in cross section, a first example of a composite reinforcer in accordance with the invention. This composite reinforcer, denoted R-1, is composed of a reinforcing thread (10) composed of a unitary filament or monofilament having a relatively large diameter (for example between 0.10 and 0.50 mm), for example made of carbon steel, which is covered with a layer (11) comprising a thermoplastic polymer having a positive Tg, for example made of polyamide or of polyester, and a diene elastomer, for example a BR, SBR or NR, of the epoxidized type; the minimum thickness of this layer is denoted Em in this FIG. 1.

FIG. 2 gives a diagrammatic representation, in cross section, of a second example of a composite reinforcer in accordance with the invention. This composite reinforcer, denoted R-2, is composed of a reinforcing thread (20) composd in fact of two unitary filaments or monofilaments (20a, 20b) having a relatively large diameter (for example between 0.10 and 0.50 mm) twisted or cabled together, for example made of carbon steel; the reinforcing thread (20) is covered with a layer (21), with a minimum thickness Em, comprising a thermoplastic polymer having a positive Tg (Tg₁), for example made of polyamide or of polyester, and an epoxidized diene elastomer, for example of the SBR, BR or NR type.

FIG. 3 gives a diagrammatic representation, in cross section, of another example of a composite reinforcer according to the invention. This composite reinforcer, denoted R-3, is composed of three reinforcing threads (30), each composed of two monofilaments (30a, 30b) having a relatively large diameter (for example between 0.10 and 0.50 mm) twisted or cabled together, for example made of carbon steel; the assembly formed by the three reinforcing threads (30), for example aligned, is covered with a layer (31) comprising a thermoplastic polymer having a positive Tg (Tg₁), for example made of polyamide or of polyester, and an epoxidized diene elastomer, for example of the BR, SBR or NR type.

FIG. 4 gives a diagrammatic representation, still in cross section, of another example of a composite reinforcer according to the invention. This composite reinforcer R-4 comprises a reinforcing thread (40) consisting of a steel cord of 1+6 construction, with a central thread or core thread (41a) and six filaments (41b) of the same diameter which are wound together in a helix around the central thread. This reinforcing cord or thread (40) is covered with a layer (42) of a polymer composition comprising a polyamide and an epoxidized diene elastomer, for example a BR, SBR or NR.

In the composite reinforcers in accordance with the invention, such as those represented diagrammatically, for example, in FIGS. 1 to 4 above, the minimum thickness Em of the sheath surrounding the reinforcing thread or threads can vary to a very great extent depending on the specific conditions for implementing the invention. It is preferably between 1 μm and 2 mm and more preferably between 10 μm and 1 mm.

In the case where several reinforcing threads (in particular several cords) are used, the coating layer or sheath can be deposited individually on each of the reinforcing threads (in particular on each of the cords) (as a reminder, these reinforcing threads may or may not be unitary), as illustrated, for example, in FIGS. 1, 2 and 4 commented upon above, or else can be deposited collectively on several of the reinforcing threads (in particular on several of the cords) appropriately arranged, for example aligned along a main direction, as illustrated, for example, in FIG. 3.

The composite reinforcer of the invention is capable of being prepared according to a specific process comprising at least, as essential stage, that of individually covering the reinforcing thread or each reinforcing thread, or collectively covering several reinforcing threads, by a layer of the polymer composition comprising at least the thermoplastic polymer having a positive glass transition temperature and the epoxidized diene elastomer.

This stage can be carried out in a way known to a person skilled in the art; it consists, for example, in making the reinforcing thread pass through a die of suitable diameter in an extrusion head heated to an appropriate temperature.

According to a preferred embodiment, the reinforcing thread or threads are preheated, for example by induction heating or by IR radiation, before passing into the extrusion head. On exiting from the extrusion head, the reinforcing thread or threads thus sheathed are then sufficiently cooled so as to solidify the polymer layer, for example with air or another cold gas, or by passing through a water bath, followed by a drying stage.

The composite reinforcer in accordance with the invention thus obtained can optionally be subjected to a thermo-oxidative treatment, directly on exiting from extrusion or subsequently after cooling.

By way of example, in order to obtain a sheathed reinforcing thread having a total diameter of approximately 1 mm, a reinforcing thread with a diameter of approximately 0.6 mm, for example a metal cord composed simply of two individual monofilaments with a diameter of 0.3 mm twisted together (as illustrated, for example, in FIG. 2), is covered with a layer of a composition formed of polyamide and of epoxidized SBR, having a maximum thickness equal to approximately 0.4 mm, on an extrusion/sheathing line comprising two dies, a first die (counter-die or upstream die) having a diameter equal to approximately 0.65 mm and a second die (or downstream die) having a diameter equal to approximately 0.95 mm, both dies being positioned in an extrusion head heated to approximately 240° C. The mixture formed of polyamide and epoxidized SBR, brought to a temperature of 240° C. in the extruder, thus covers the cord via the sheathing head, at a rate of forward progression of the thread typically equal to several tens of m/min, for an extrusion pump flow rate typically of several tens of g/min. The mixing of polyamide and epoxidized SBR can be carried out in situ, in the same extrusion head, the two components then being introduced, for example, via two different feed hoppers; according to another possible implementational example, polyamide and epoxidized SBR can also be used in the form of a mixture manufactured beforehand, for example in the form of granules, a single feed hopper then being sufficient. On exiting from this sheathing, the cord can be immersed in a tank filled with cold water for cooling, before the take-up reel is passed into the oven for drying.

On conclusion of this sheathing operation, for example directly on exiting from the sheathing head, the composite reinforcer can, according to a preferred embodiment of the invention, be subjected to a heat treatment under air (or thermo-oxidative treatment) by passing through, for example, a tunnel oven, for example several metres in length, in order to be subjected therein to a heat treatment under air (thermo-oxidative treatment). This treatment temperature is, for example, between 150° C. and 300° C., for treatment times from a few seconds to a few minutes as the case may be (for example between 10 s and 10 min), it being understood that the duration of the treatment will be shorter the higher the temperature and that the heat treatment obviously must not lead to remelting or even excessive softening of the thermoplastic materials used.

Thus completed, the composite reinforcer of the invention is advantageously cooled, for example in air, so as to prevent problems of undesirable sticking while it is being wound onto the final take-up reel.

If appropriate, a person skilled in the art will know how to adjust the temperature and the duration of the optional heat treatment above according to the specific conditions for implementing the invention, in particular according to the exact nature of the composite reinforcer manufactured, especially according to whether the treatment is carried out on monofilaments taken individually, cords composed of several monofilaments or groups of such monofilaments or cords, such as strips. In particular, a person skilled in the art will have the advantage of scanning the treatment temperatures and times so as to search, by successive approximations, for the operating conditions giving the best adhesion results, for each specific embodiment of the invention.

The stages of the process of the invention which are described above might be supplemented by a final treatment for three-dimensional crosslinking of the reinforcer, in order to further reinforce the intrinsic cohesion of its sheath, in particular in the cases where this composite reinforcer is intended for subsequent use at a relatively high temperature, typically greater than 100° C.

This crosslinking can be carried out by any known means, for example by physical crosslinking means, such as ion or electron bombardment, or by chemical crosslinking means, for example by introducing a crosslinking agent into the polymer composition, for example while it is being extruded, or else by introducing a vulcanization system (that is to say, a sulphur-based crosslinking system) into this composition.

Crosslinking can also be obtained during the curing of the tyres (or more generally rubber articles) which the composite reinforcer of the invention is intended to reinforce, by means of the intrinsic crosslinking system present in the constituent diene rubber compositions of such tyres (or rubber articles) and coming into contact with the composite reinforcer of the invention.

The composite reinforcer of the invention can be used directly, that is to say without requiring any additional adhesive system, as reinforcing element for a diene rubber matrix, for example in a tyre. It can advantageously be used to reinforce tyres for all types of vehicles, in particular passenger vehicles or industrial vehicles, such as heavy-duty vehicles.

By way of example, the appended FIG. 5 gives a highly diagrammatic representation (without observing a specific scale) of a radial section of a tyre in accordance with the invention for a vehicle of the passenger vehicle type.

This tyre 1 comprises a crown 2 reinforced by a crown reinforcement or belt 6, two sidewalls 3 and two beads 4, each of these beads 4 being reinforced with a bead wire 5. The crown 2 is surmounted by a tread, not represented in this diagrammatic figure. A carcass reinforcement 7 is wound around the two bead wires 5 in each bead 4, the turn-up 8 of this reinforcement 7 being, for example, positioned towards the outside of the tyre 1, which is here represented fitted onto its wheel rim 9. The carcass reinforcement 7 is, in a way known per se, composed of at least one ply reinforced by “radial” cords, for example of textile or metal, that is to say that these cords are positioned virtually parallel to one another and extend from one bead to the other so as to form an angle of between 80° and 90° with the median circumferential plane (plane perpendicular to the axis of rotation of the tyre which is situated at mid-distance from the two beads 4 and passes through the middle of the crown reinforcement 6).

This tyre 1 of the invention has, for example, the essential characteristic that at least one of its crown or carcass reinforcements comprises a composite reinforcer according to the invention. According to another example of possible embodiment of the invention, it is, for example, the bead wires 5 which might be composed of a composite reinforcer according to the invention.

### EXAMPLES OF THE IMPLEMENTATION OF THE INVENTION

### Test 1—Manufacture of the Composite Reinforcers

First of all, composite reinforcers in accordance with the invention are manufactured in the following way. The starting reinforcing thread is a steel cord for pneumatic tyres (standard steel comprising 0.7% by weight of carbon), of 1×2 construction, composed of two individual threads or monofilaments 0.30 mm in diameter twisted together according to a helical pitch of 10 mm. Its diameter is 0.6 mm.

This cord is covered with a mixture of polyamide 6 (Ultramid B33 from BASF; M.p. equal to approximately 230° C.) and of an epoxidized SBR (degree of epoxidation equal to 11% (mol); Tg −40° C.; 28% of styrene, 55% of 1,4- bonds and 17% of 1,2- bonds) on an extrusion/sheathing line by passing through an extrusion head heated to 240° C. and comprising two dies, an upstream die 0.63 mm in diameter and a downstream die 0.92 mm in diameter. The polymer mixture, consisting of the polyamide 6 (pump rate of approximately 63 g/min) and of the epoxidized SBR (pump flow rate of approximately 14 g/min) (according to polyamide/SBR weight ratios of 82/18), is brought to a temperature of 240° C. and thus covers the thread (preheated to approximately 174° C. by passing through an HF generator) progressing forward at a rate of 60 m/min. On exiting from the sheathing head, the composite reinforcer obtained is continuously immersed in a cooling tank filled with water at 5° C., in order to cool its sheath, and then dried using an air nozzle.

The glass transition temperature, Tg₁, of the polyamide used above is equal to approximately +45° C. (for example measured according to the following procedure: 822-2 DSC device from Mettler Toledo; helium atmosphere; samples brought beforehand from ambient temperature (20° C.) to 100° C. (20° C./min) and then rapidly cooled down to −140° C., before final recording of the DSC curve from −140° C. to +300° C. at 20° C./min).

On conclusion of this sheathing, in these examples, the assembly is subjected to a heat treatment for a time of approximately 100 s by passing at 3 m/min through a tunnel oven, under an ambient atmosphere (air), brought to a temperature of 270° C. Composite reinforcers in accordance with the invention (Reinforcers R-2 as represented diagrammatically in FIG. 2), consisting of the starting steel cord sheathed with its layer of polymer composition (polyamide and epoxidized diene elastomer), the adhesive properties of which are optimal, are thus obtained.

In the above test, in order to determine the best operating conditions for the heat treatment, a temperature scan from 160° C. to 280° C., for four treatment times (50 s, 100 s, 200 s and 400 s), was carried out beforehand.

### Test 2—Adhesion Tests

The quality of the bond between the rubber and the composite reinforcers manufactured above is subsequently assessed by a test in which the force needed to extract the reinforcers from a vulcanized rubber composition (“vulcanizate”) is measured. This rubber composition is a conventional composition used for the calendering of tyre belt metal plies, based on natural rubber, carbon black and standard additives.

The vulcanizate is a rubber block composed of two sheets having dimensions of 200 mm by 4.5 mm and having a thickness of 3.5 mm, applied against each other before curing (the thickness of the resulting block is then 7 mm) It is during the production of this block that the composite reinforcers (15 strands in total) are trapped between the two rubber sheets in the raw state, an equal distance apart and while leaving to protrude, on either side of these sheets, a composite reinforcer end having a length sufficient for the subsequent tensile test. The block comprising the reinforcers is then placed in a suitable mould and then cured (cross-linked) under pressure. The curing temperature and the curing time are adapted to the targeted test conditions and left to the discretion of a person skilled in the art; by way of example, in the present case, the block is cured at 160° C. for 15 min under a pressure of 16 bar.

On conclusion of the curing, the test specimen, thus consisting of the vulcanized block and the 15 reinforcers, is placed between the jaws of a suitable tensile testing machine in order to make it possible to pull each reinforcer individually out of the rubber, at a given rate and a given temperature (for example, in the present case, at 50 mm/min and 25° C.). The adhesion levels are characterized by measuring the “pull-out” force (denoted Fₘₐₓ) for pulling the reinforcers out of the test specimen (average over 15 tensile tests).

It was found that the composite reinforcer of the invention, despite the fact that it is devoid of RFL adhesive (or any other adhesive), exhibits a particularly high and unexpected pull-out force Fₘₐₓ, since it is increased by approximately 65% compared to the reference pull-out force measured on a control composite reinforcer sheathed simply with polyamide 6 and bonded with a conventional RFL adhesive.

Under the same conditions, a control composite reinforcer sheathed simply with polyamide 6 (thus without epoxidized SBR) but devoid of RFL adhesive (or any other adhesive) exhibited no adhesion to the rubber (pull-out force virtually equal to zero).

In conclusion, the composite reinforcer of the invention, by its self-adhesive nature, constitutes a particularly advantageous alternative, in view of the very high levels of adhesion obtained, to the composite reinforcers of the prior art sheathed with a thermoplastic material, such as polyamide or polyester, which require in a known way the use of an adhesive of the RFL type to ensure their subsequent adhesion to the rubber.

1.-14. (canceled)

15. A composite reinforcer comprising:
one or more reinforcing threads; and
a layer of a polymer composition which covers the one or more reinforcing threads, individually each thread or collectively several threads,
wherein the polymer composition comprises:
at least one thermoplastic polymer, the glass transition temperature of which is positive, and
an epoxidized diene elastomer.

16. The composite reinforcer according to claim 15, wherein the at least one thermoplastic polymer has a glass transition temperature greater than +20° C.

17. The composite reinforcer according to claim 15, wherein the at least one thermoplastic polymer is a polyester or an aliphatic polyamide.

18. The composite reinforcer according to claim 17, wherein the at least one thermoplastic polymer is an aliphatic polyamide.

19. The composite reinforcer according to claim 15, wherein the epoxidized diene elastomer is selected from the group consisting of natural rubber, synthetic polyisoprenes, polybutadienes, butadiene copolymers, isoprene copolymers, and mixtures thereof.

20. The composite reinforcer according to claim 15, wherein the epoxidized diene elastomer is a natural rubber or a synthetic polyisoprene.

21. The composite reinforcer according to claim 15, wherein the epoxidized diene elastomer is a polybutadiene or a butadiene/styrene copolymer.

22. The composite reinforcer according to claim 15, wherein a minimum thickness of the layer is between 1 μm and 2 mm.

23. The composite reinforcer according to claim 15, wherein the one or more reinforcing threads is a metal thread.

24. The composite reinforcer according to claim 23, wherein the metal thread is a thread made of carbon steel.

25. An article or a semi-finished product comprising a rubber composition that includes a composite reinforcer according to claim 15.

26. A tire comprising a composite reinforcer according to claim 15.

27. A process for manufacture of a composite reinforcer according to claim 15, comprising a step of covering the one or more reinforcing threads individually or collectively by a layer of the polymer composition.

28. The process according to claim 27, further comprising a step of subsequently subjecting the composite reinforcer to a thermo-oxidative treatment.
